(19) United States
(12) Patent Application Publication
(10) Pub. No.: US 2018/0146061 A1
(43) Pub. Date: May 24, 2018

(54) Mediation of Data Exchange Among Trusted Devices

(71) Applicant: FROST NEWCO25, INC., San Juan Capistrano, CA (US)

(72) Inventor: Matthias Oberdorfer, La Mesa, CA (US)

(21) Appl. No.: 15/360,891

(22) Filed: Nov. 23, 2016

(51) Int. Cl. H04L 29/08; G06Q 30/06

(52) U.S. Cl. CPC H04L 67/303; G06F 8/70; G06Q 30/06; H04L 67/12

(57) ABSTRACT

There are provided systems and methods for mediating data exchange among devices. Such a method includes receiving a data from at least a first registered device having a device profile stored in a device registry, generating a ledger entry corresponding to the data in a data exchange ledger, and transmitting a data availability notification describing the data to one or more other registered devices based on their respective device profiles. The method also includes receiving a data acquisition request for the data from at least a second registered device included among the one or more other registered devices, mediating a transaction for an exchange of the data between the first registered device(s) and the second registered device(s), and updating the ledger entry and the respective device profiles of the first registered device(s) and the second registered device(s) based on the transaction.

### BACKGROUND

The introduction of social media platforms for the exchange of information among human beings has represented a paradigm shift in the evolution of social interaction. Of the over seven billion people presently populating planet Earth, approximately two billion use one or more social media platforms. Those social media users rely on the real-time communications over vast distances and cultural barriers enabled by social media to entertain and inform themselves, and even to affect social change, as evidenced by the role of social media in various world events.

The advantages accruing from the dynamic exchange of information using reliable communication channels may not be limited to human interactions, however. For example, it is estimated that by 2020 there will be approximately fifty billion connected devices capable of participating in the Internet of things (IoT). Although those connected devices may be capable of sharing data in principle, in practice the extent to which such data sharing occurs may be limited by the inability of a connected device to identify another authorized or trusted device with which data sharing can be engaged in safely. Consequently a solution for mediating data exchange among connected devices that is capable of increasing the efficiency, velocity, and effectiveness with which data can be exchanged between trusted devices is needed.

### SUMMARY

There are provided systems and methods for mediating data exchange among devices, substantially as shown in and/or described in connection with at least one of the figures, and as set forth more completely in the claims.

### BRIEF DESCRIPTION OF THE DRAWINGS

FIG. 1 shows a diagram of an exemplary system for mediating data exchange among devices, according to one implementation;

FIG. 2 shows another exemplary implementation of a system for mediating data exchange among devices;

FIG. 3 shows an exemplary system and a computer-readable non-transitory medium including instructions for mediating data exchange among devices;

FIG. 4 is a flowchart presenting an exemplary method for use by a system to mediate data exchange among devices; and

FIG. 5 shows an exemplary use case in which mediation of data exchange between aircraft is performed.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As noted above, the advantages accruing from the dynamic exchange of information using reliable communication channels may not be limited to human interactions. For example, and as also noted above, it is estimated that by 2020 there will be approximately fifty billion connected devices capable of participating in the Internet of things (IoT). Although those connected devices may be capable of sharing data in principle, in practice the extent to which such data sharing occurs may be limited by the inability of a connected device to identify another authorized or trusted device with which data sharing can be engaged in safely. Consequently a solution for mediating data exchange among connected devices that is capable of increasing the efficiency, velocity, and effectiveness with which data can be exchanged between trusted devices is needed.

The present application addresses the challenge described above, as well as analogous obstacles to the facilitation of device interaction, by providing systems and methods for mediating data exchange among devices. According to one implementation, for example, such a system and method may be used to establish a marketplace for commercial transactions in which data is exchanged between or among devices.

As disclosed in the present application, a system for mediating data exchange among devices includes a hardware processor for executing a data exchange mediating software code stored in the system memory. The data exchange mediating software code includes a data exchange ledger and a device registry storing a device profile for each device registered with the system.

The system is configured to receive data from one or more registered devices and to generate a ledger entry corresponding to the data, in the data exchange ledger. The system is also configured to transmit a data availability notification describing the data to one or more other registered devices identified as potentially desirous recipients of the data based on their respective device profiles. The system is further configured to receive a data acquisition request from one or more of the registered devices to which the data availability notification is transmitted, and to mediate a transaction for an exchange of the data between the registered device or devices providing the data and the registered device or devices seeking to acquire the data. In addition, the system is configured to update the ledger entry corresponding to the data, as well as the respective device profiles of the devices participating in the transaction, based on the transaction.

The systems and methods for mediating data exchange among devices that are disclosed in the present application can be used to improve the efficiency and security of data transfer across a wide variety of device interactions. For example, in one implementation, data may be provided as a gift, free of cost, between or among substantially identical devices, or between or among devices under common ownership or control. In another implementation, data may be provided as a gift, or may be sold, between or among devices having one or more substantially identical components in common. In various other implementations, the disclosed systems and methods may be used to analyze or modify received data prior to mediating a transaction for exchange of the data, or to provide a marketplace environment in which devices can negotiate with one another for the exchange of data.

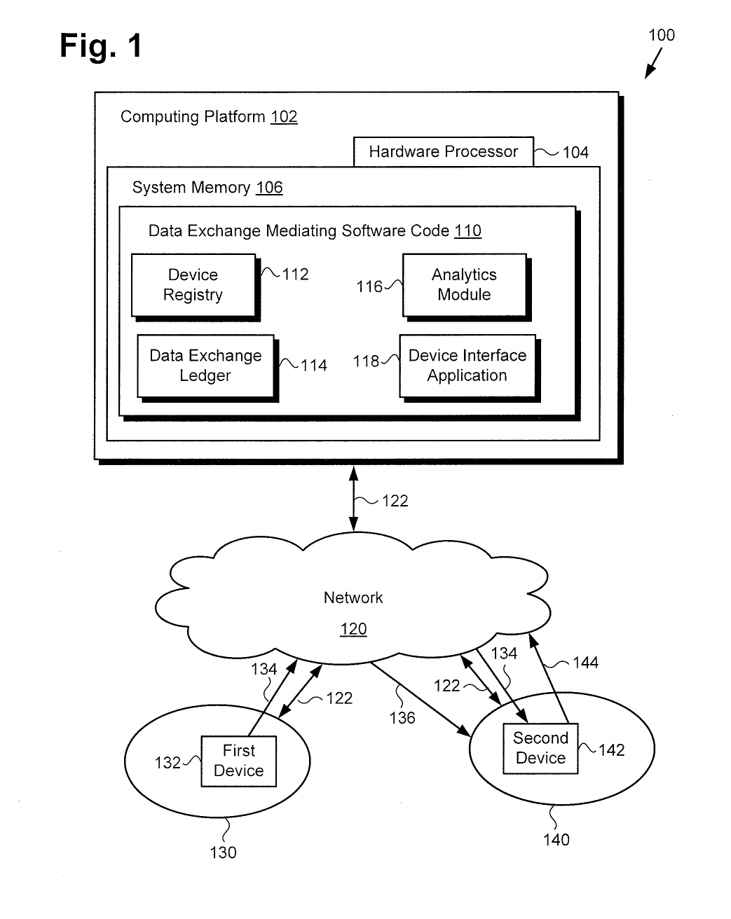

FIG. 1 shows a diagram of exemplary system 100 for mediating data exchange among devices, according to one implementation. System 100 includes computing platform 102, which itself includes hardware processor 104 and system memory 106 storing data exchange mediating software code 110. As shown in FIG. 1, data exchange mediating software code 110 includes device registry 112, data exchange ledger 114, analytics module 116, and device interface application 118. In addition, FIG. 1 shows registered devices 130 including first registered device 132 providing data 134, and other registered devices 140 including second registered device 142 acquiring data 134. Also shown in FIG. 1 are communication network 120, network communication links 122 interactively connecting registered devices 130 and 140 with system 100, data availability notification 136, and data acquisition request 144.

According to the implementation shown in FIG. 1, registered devices 130 and 140 may interact with one another, as well as with system 100, over communication network 120, for example to exchange data 134. In one such implementation, system 100 may correspond to one or more web servers, accessible over a packet network such as the Internet, for example. Alternatively, system 100 may correspond to one or more servers supporting a local area network (LAN), or included in another type of limited distribution network. Moreover, in some implementations, system 100 may be configured to mediate an exchange of data 134 between one or more of registered devices 130 and one or more of registered devices 140 over a peer-to-peer (P2P) network linking registered devices 130 and 140.

It is noted that although FIG. 1 depicts device registry 112, data exchange ledger 114, analytics module 116, and device interface application 118 of data exchange mediating software code 110 as being mutually co-located in system memory 106, that representation is merely provided as an aid to conceptual clarity. More generally, system 100 may include one or more computing platforms 102, such as computer servers for example, which may be co-located, or may form an interactively linked but distributed system, such as a cloud based system, for instance. As a result, hardware processor 104 and system memory 106 may correspond to distributed processor and memory resources within system 100. Thus, it is to be understood that device registry 112, and/or data exchange ledger 114, and/or analytics module 116, and/or device interface application 118 of data exchange mediating software code 110 may be stored remotely from one another within the distributed memory resources of system 100.

Hardware processor 104 is configured to execute data exchange mediating software code 110 to receive data 134 from one or more of registered devices 130, such as first registered device 132, and to generate a ledger entry corresponding to data 134 in data exchange ledger 114. It is noted that each of registered devices 130 and 140 is a trusted device for the purposes of data exchange mediated by system 100 by virtue of having a device profile stored in device registry 112. Such a device profile may include authentication information for the device, as well as descriptive data identifying a manufacturer, owner, or user of the device, performance specifications and safe operating ranges for the device, and/or information describing components of the device, for example.

Hardware processor 104 is further configured to execute data exchange mediating software code 110 to transmit data availability notification 136 describing data 134 to one or more of registered devices 140 based on their respective device profiles, and to receive data acquisition request 144 for data 134 from one or more of registered devices 140, such as second registered device 142. Hardware processor 104 is also configured to execute data exchange mediating software code 110 to mediate a transaction for an exchange of data 134 between one or more of registered devices 130 and one or more of registered devices 140. In addition, hardware processor 104 is configured to execute data exchange mediating software code 110 to update the ledger entry corresponding to data 134 in data exchange ledger 114, and the respective device profiles of the registered devices engaged in the transaction exchanging data 134 stored in device registry 112.

It is noted that, in some implementations, the transaction mediated by system 100 may include a sale of data 134 from one or more of registered devices 130 to one or more of registered devices 140. However, in other implementations, a transaction other than a purchase may be mediated. For example, in various implementations, data 134 may be provided as a gift from one or more of registered devices 130 to one or more of registered devices 140, or may be offered in trade, for example in exchange for other data received in return, or for a credit to be recorded in data exchange ledger 114.

It is noted that although system 100 has been described in terms of data 134 being both the data received by system 100 and the data exchanged in the transaction mediated by system 100, that characterization is merely exemplary. In some implementations, for example, system 100 may merely receive a descriptive data corresponding to data 134. In those implementations, the exchange of data 134 between one or more of registered devices 130 and one or more of registered devices 140 may occur over a P2P network in which system 100 is not a direct participant.

In other implementations, system 100 may be configured to receive data 134, but hardware processor 104 may be configured to analyze data 134 and/or to modify data 134 using analytics module 116, prior to mediating a transaction for exchange of data 134. In those implementations, the “exchange of data” mediated by system 100 may result in one or more of registered devices 140 acquiring data corresponding to data 134 but not in fact being an exact copy of data 134.

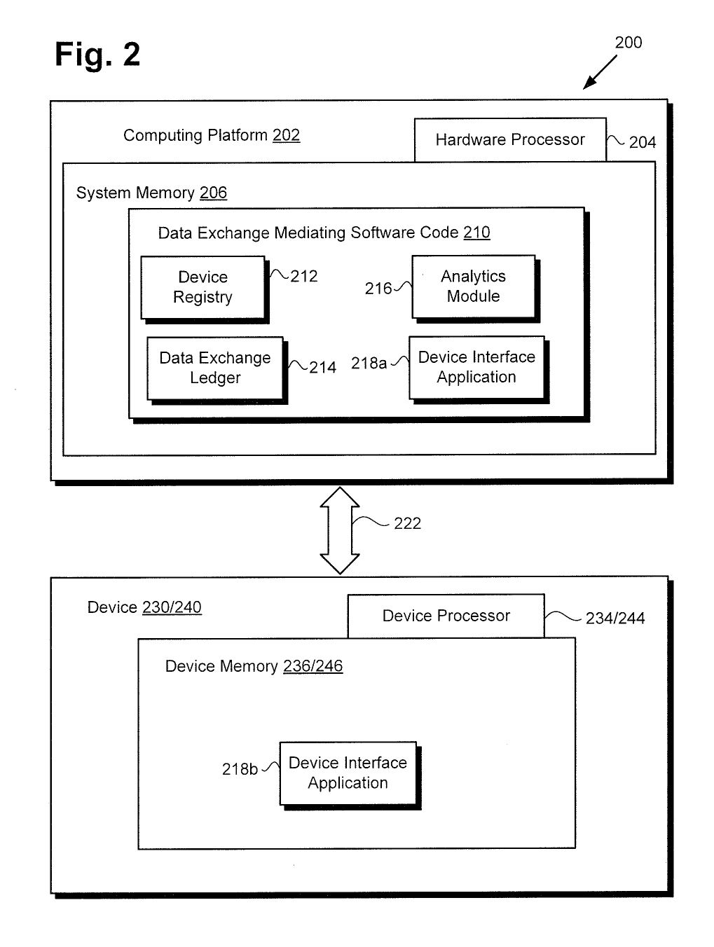

Continuing to FIG. 2, FIG. 2 shows an exemplary implementation of system 200 for mediating data exchange among devices in combination with a more detailed representation of device 230/240. System 200 includes computing platform 202, which is shown to be interactively connected to registered device 230/240 over network communication link 222. Computing platform 202 includes hardware processor 204, and system memory 206 storing data exchange mediating software code 210. As shown in

FIG. 2, data exchange mediating software code 210 includes device registry 212, data exchange ledger 214, analytics module 216, and device interface application 218a. As further shown in FIG. 2, registered device 230/240 includes device hardware processor 234/244, and device memory 236/246 storing device interface application 218b.

Network communication link 222, and system 200 including computing platform 202 having hardware processor 204 and system memory 206, correspond in general to network communication link 122, and system 100 including computing platform 102 having hardware processor 104 and system memory 106, in FIG. 1. In addition, data exchange mediating software code 210 including device registry 212, data exchange ledger 214, analytics module 216, and device interface application 218a, in FIG. 2, corresponds to data exchange mediating software code 110 including device registry 112, data exchange ledger 114, analytics module 116, and device interface application 118, in FIG. 1. In other words, data exchange mediating software code 210 including device registry 212, data exchange ledger 214, analytics module 216, and device interface application 218a may share any of the characteristics attributed to corresponding data exchange mediating software code 110 including device registry 112, data exchange ledger 114, analytics module 116, and device interface application 118, shown in FIG. 1 and described in the present application.

Registered device 230/240 corresponds in general to any of registered devices 130 or 140, in FIG. 1. Moreover, device interface application 218b corresponds to device interface application 118/218a. According to the exemplary implementation shown in FIG. 2, device interface application 218b is located in device memory 236/246, having been received from system 200 via network communication link 222. In one implementation, network communication link 222 corresponds to transfer of device interface application 218b over a packet network, for example. Once transferred, for instance by being downloaded over network communication link 222, device interface application 218b may be persistently stored in device memory 236/246 and may be executed locally on registered device 230/240 by device hardware processor 234/244.

Device hardware processor 234/244 may be the central processing unit (CPU) for registered device 230/240, for example, in which role device hardware processor 234/244 runs the operating system for registered device 230/240 and executes device interface application 218b. In the exemplary implementation of FIG. 2, registered device 230/240 can utilize device interface application 218b to interact with system 200 so as to provide data and/or data acquisition requests to system 200, to receive data availability notifications from system 200, and to acquire data through transactions mediated by system 200.

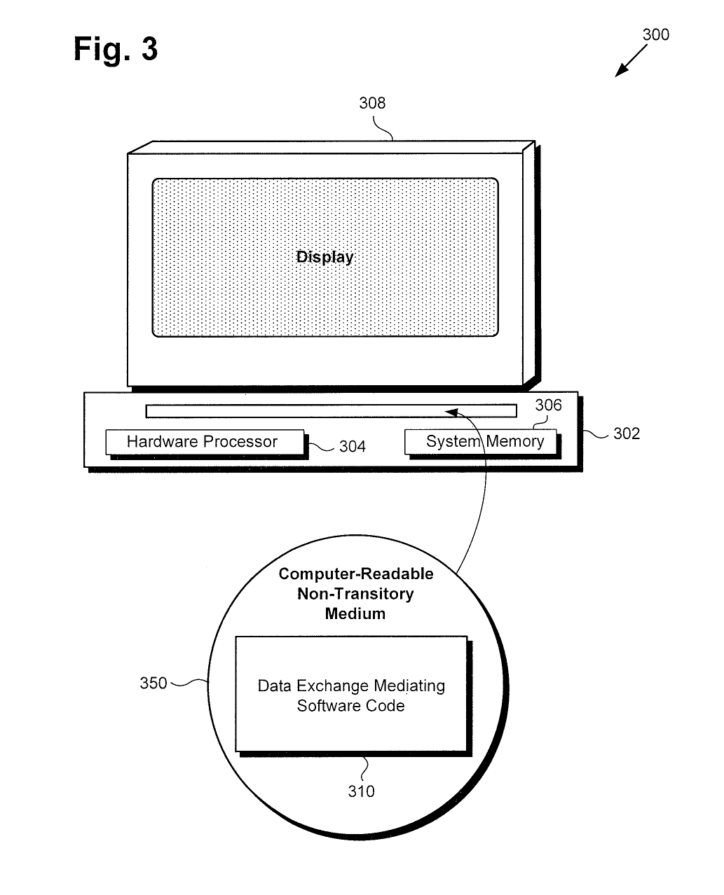

Referring to FIG. 3, FIG. 3 shows exemplary system 300 and a computer-readable non-transitory medium including instructions for mediating data exchange among devices, according to one implementation. System 300, in FIG. 3, includes computing platform 302 including hardware processor 304 and system memory 306, interactively linked to display 308. Display 308 may take the form of a liquid crystal display (LCD), a light-emitting diode (LED) display, an organic light-emitting diode (OLED) display, or another suitable display screen that performs a physical transformation of signals to light. System 300 including computing platform 302 having hardware processor 334 and system memory 336 corresponds in general to system 100/200 including computing platform 102/202 having hardware processor 104/204 and system memory 106/206, in FIG. 1/2.

Also shown in FIG. 3 is computer-readable non-transitory medium 350 having data exchange mediating software code 310 stored thereon. The expression “computer-readable non-transitory medium,” as used in the present application, refers to any medium, excluding a carrier wave or other transitory signal, that provides instructions to hardware processor 304 of system 300. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM), and FLASH memory. According to the implementation shown in FIG. 3, computer-readable non-transitory medium 350 provides data exchange mediating software code 310 for execution by hardware processor 304 of system 300. Data exchange mediating software code 310 corresponds in general to data exchange mediating software code 110/210, in FIG. 1/2, and is capable of performing all of the operations attributed to those corresponding features by the present application.

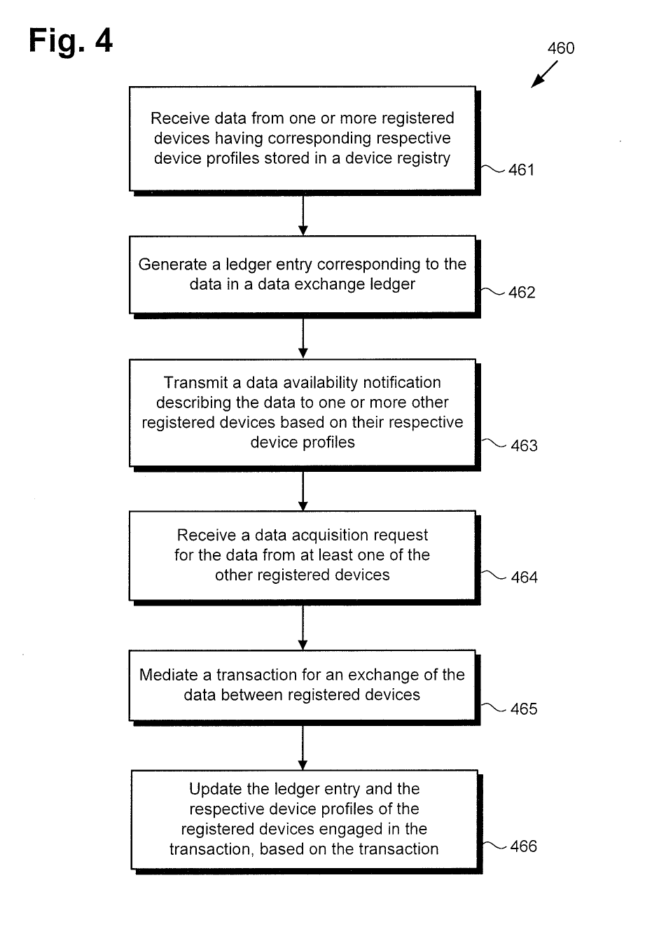

The systems for mediating data exchange among devices discussed above by reference to FIGS. 1, 2, and 3, will be further described below with reference to FIG. 4. FIG. 4 presents flowchart 460 outlining an exemplary method for use by a system to mediate data exchange among devices.

Flowchart 460 begins with receiving data 134 from one or more of registered devices 130 having corresponding respective device profiles stored in device registry 112 (action 461). Data 134 may be received by data exchange mediating software code 110/210/310 of system 100/200/300, executed by respective hardware processor 104/204/304. As shown in FIG. 1, data 134 may be received by data exchange mediating software code 110/210/310 from first registered device 132 of registered devices 130, via communication network 120 and network communication links 122.

Data 134 may include a wide variety of data types. For example, data 134 may include performance data corresponding to the operation of first registered device 132, or one or more components of first registered device 132. Alternatively, or in addition, data 134 may include environmental data, such as hyper-local weather data for a micro-environment surrounding first device 132. As a specific example, data 134 may include hyper-local weather data generated by sensors in the nose of an aircraft corresponding to first registered device 132 during take-off. Moreover, in that specific case, data 134 may further include performance data of one or more engines or other systems of the aircraft, during take-off, or at any time during flight, for example.

As other merely exemplary use cases, data 134 may correspond to the performance or micro-environment of a vehicle, or to the performance and environment of a fixed device or network of devices such as a renewable energy array of wind turbines or smart photovoltaic panels. In addition to performance and/or diagnostic data, data 134 may include authentication data enabling system 100/200/300 or a trusted third party to identify first registered device 132. It is noted that in some implementations, data 134 may include authentication data for first registered device 132 and metadata describing data available from first registered device 132, but may not include the available data itself. Data 134 may be provided to system 100/200/300 by first registered device 132 using device interface application 218b.

Flowchart 460 continues with generating a ledger entry corresponding to data 134 in data exchange ledger 114/214 (action 462). A ledger entry corresponding to data 134 may be generated in data exchange ledger 114/214 by data exchange mediating software code 110/210/310 of system 100/200/300, executed by respective hardware processor 110/210/310, executed by respective hardware processor 104/204/304. Data exchange ledger 114/214 may be a Blockchain type transaction ledger for the exchange of data 134 between or among registered users 130 and other registered users 140, for example.

Flowchart 460 continues with transmitting data availability notification 136 describing data 134 to one or more other registered devices 140 based on their respective device profiles (action 463). The transmission of data availability notification 136 describing data 134 may be performed by data exchange mediating software code 110/210/310 of system 100/200/300, executed by respective hardware processor 104/204/304.

For example, other registered devices 140 may be identified as potentially desirous recipients of data 134 based on their respective device profiles. Such an identification of other registered devices 140 as recipient devices for data availability notification 136 may be performed by data exchange mediating software code 110/210/310 using analytics module 116/216 to analyze data 134 and/or to correlate data 134 with the respective device profiles of other registered devices 140 before transmission of data availability notification 136.

As noted above, each of registered devices 130 and 140 is a trusted device for the purposes of data exchange mediated by system 100/200/300 by virtue of having a device profile stored in device registry 112/212. As further noted above, in addition to authentication information for a particular device, its device profile may include descriptive data identifying a manufacturer, owner, or user of the device, performance specifications and safe operating ranges for the device, and/or information describing components of the device, for example.

For instance, other registered devices 140 may have data availability notification 136 transmitted to them because other registered devices 140 have respective device profiles containing substantially identical device descriptive data to that of first registered device 132 from which data 134 is received. Alternatively, other registered devices 140 may have data availability notification 136 transmitted to them because each of other registered devices 140 includes at least one component in common with first registered device 132.

In some implementations, other registered devices 140 may have data availability notification 136 transmitted to them based on the volume of data 134 received from registered devices 130 (also referred to herein as “the chatter from registered devices 130”). For example, where the chatter from registered devices 130 satisfies a predetermined threshold, all other registered devices having a common owner, manufacturer, or including one or more parts or types of parts in common, for example, may have data availability notification 136 transmitted to them in action 463.

Flowchart 460 continues with receiving data acquisition request 144 for data 134 from one or more of other registered devices 140 (action 464). Data acquisition request 144 for data 134 may be received by data exchange mediating software code 110/210/310 of system 100/200/300, executed by respective hardware processor 104/204/304. Data acquisition request 144 may be received by data exchange mediating software code 110/210/310 from second registered device 142 of other registered devices 140, via communication network 120 and network communication links 122.

Flowchart 460 continues with mediating a transaction for an exchange of data 134 between one or more of registered devices 130 and one or more of other registered devices 140 (action 465). Mediation of the transaction for exchange of data 134 may be performed by data exchange mediating software code 110/210/310 of system 100/200/300, executed by respective hardware processor 100/210/304.

As noted above, the transaction for the exchange of data 134 mediated by data exchange mediating software code 110/210/310 may be structured as a gift or as a sale, for example. Moreover, in implementations in which the transaction for the exchange of data 134 mediated by data exchange mediating software code 110/210/310 is to be a sale, data exchange mediating software code 110/210/310 may be further executed by respective hardware processor 104/204/304 to broker a negotiated sale price for data 134. As a specific example, where first registered device 132 provides data 134 and second registered device 142 requests data 134 via data acquisition request 144, data exchange mediating software code 110/210/310 may act as broker in a negotiation between first registered device 132 and second registered device 142 for exchange, i.e., sale, of data 134.

Although not included in exemplary flowchart 460, in some implementations, data exchange mediating software code 110/210/310 may be further executed by respective hardware processor 104/204/304 to modify data 134 prior to the exchange of data 134 between first registered device 132 and second registered device 142. For example, data exchange mediating software code 110/210/310 may customize data 134 for use by second registered device 142 acquiring data 134, based on a request for customization from second registered device 142, or automatically, based on the device profile of second registered device 142 stored in device registry 112/212. Moreover, in some implementations, data exchange mediating software code 110/210/310 may be further executed by respective hardware processor 104/204/304 to generate new data for use by second registered device 142 based on data 134 received from first registered device 132.

Flowchart 460 may conclude with updating the ledger entry corresponding to data 134 and the respective device profiles of the devices engaged in the transaction for exchange of data 134, based on the transaction (action 466). Updating of the ledger entry corresponding to data 134 may be performed by data exchange mediating software code 110/210/310 of system 100/200/300, executed by respective hardware processor 104/204/304. As a specific example, where the transaction takes the form of a sale of data 134 by first registered device 132 to second registered device 142, updating of the ledger entry corresponding to data 134 may include identifying the date, terms, and transactions participants, i.e., in this example first registered device 132 and second registered device 142. In addition, in implementations in which data 134 is modified as part of the transaction mediated by data exchange mediating software code 110/210/310, the modification to data 134 may also be included in the updated ledger entry.

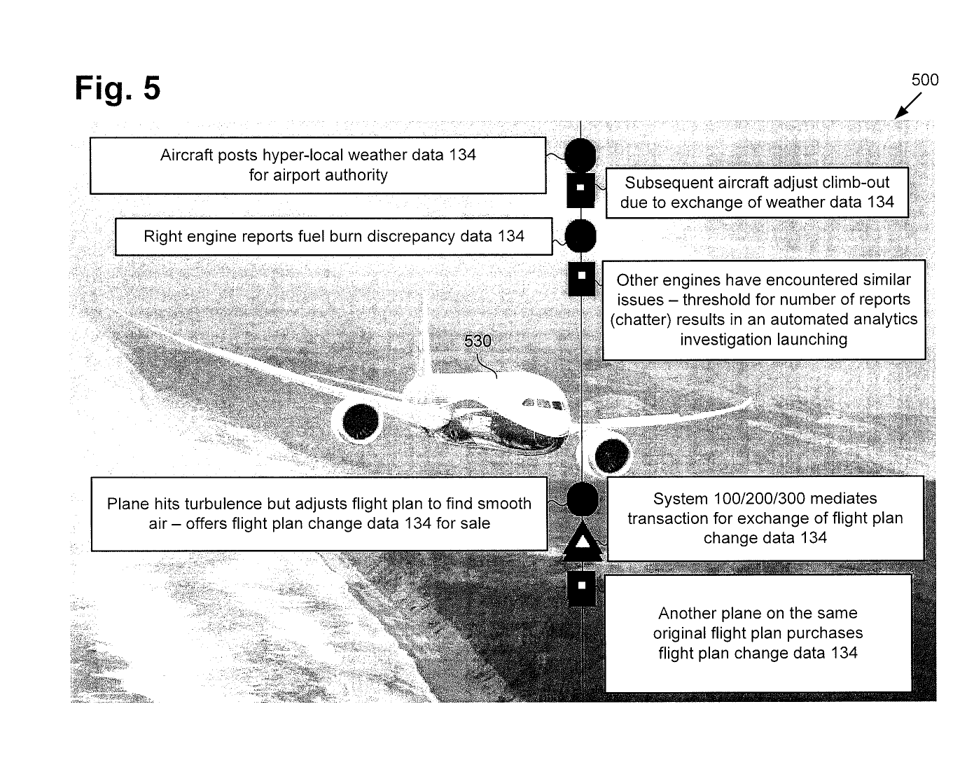

Referring to FIG. 5, FIG. 5 shows exemplary use case 500 in which mediation of data exchange between aircraft is performed. As shown in FIG. 5, aircraft 530 provides data 134 in the form of hyper-local weather data generated by sensors on aircraft 530 during take-off. Due to exchange of data 134 with other aircraft taking-off from the same airport, subsequent aircraft adjust their climb-out accordingly.

In addition, the right engine of aircraft 530 provides data 134 reporting a fuel burn discrepancy with respect to performance specifications. Chatter regarding similar fuel burn discrepancies leads to an automated analysis being performed by data exchange mediating software code 110/210/310 of system 100/200/300, using analytics module 116/216. The analysis reveals that all engines reporting the similar fuel burn discrepancies are equipped on aircraft having made more than fifty arrivals at or departures from desert runways.

Later during the flight of aircraft 530, aircraft 530 encounters turbulence and adjusts its flight plan to find smooth air. Aircraft 530 provides data 134 describing flight plan change data available for sale. Data availability notification 136 is transmitted to other aircraft that are using the same original flight plan. Data exchange mediating software code 110/210/310 of system 100/200/300 mediates a sale of the flight plan change data to a second aircraft (not shown in FIG. 5) after receiving data acquisition request 144 for the flight plan change data from the second aircraft.

Thus, the systems and methods for mediating data exchange among devices that are disclosed in the present application can be used to improve the efficiency and security of data transfer across a wide variety of device interactions. In some implementations, the data may be provided as a gift, free of cost, between or among substantially identical devices, or between or among devices under common ownership or control. In other implementations, the disclosed systems and methods may be used to provide a marketplace environment in which devices can negotiate with one another to buy and sell data.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system for mediating data exchange among devices, the system comprising:
a computing platform including a hardware processor and a system memory;
a data exchange mediating software code stored in the system memory, the data exchange mediating software code including a device registry and a data exchange ledger;
the device registry having stored therein device profiles corresponding respectively to a plurality of registered devices;
wherein the hardware processor is configured to execute the data exchange mediating software code to:
receive a data from at least a first registered device of the plurality of registered devices;
generate a ledger entry corresponding to the data in the data exchange ledger;
transmit a data availability notification describing the data to one or more other of the plurality of registered devices based on their respective device profiles;
receive a data acquisition request for the data from at least a second registered device included among the one or more other of the plurality of registered devices;
mediate a transaction for an exchange of the data between the at least first registered device and the at least second registered device; and
update the ledger entry and the respective device profiles of the at least first registered device and the at least second registered device based on the transaction.

2. The system of claim 1, wherein the data exchange mediating software code further includes an analytics module, and wherein the hardware processor is further configured to execute the data exchange mediating software code to analyze the data before transmitting the data availability notification.

3. The system of claim 1, wherein the exchange of the data comprises a gift of the data from the at least first registered device to the at least second registered device.

4. The system of claim 1, wherein the exchange of the data comprises a sale of the data from the at least first registered device to the at least second registered device.

5. The system of claim 1, wherein the at least first registered device includes at least one component in common with the at least second registered device.

6. The system of claim 1, wherein the respective device profiles of the at least first registered device and the at least second registered device contain substantially identical device descriptive data.

7. The system of claim 1, wherein the hardware processor is further configured to execute the data exchange mediating software code to modify the data before mediating the transaction.

8. A method for use by a system for mediating data exchange among devices, the system comprising a computing platform including a hardware processor and a system memory having a data exchange mediating software code including a device registry and a data exchange ledger stored therein, the method comprising:
receiving a data, using the hardware processor, from at least a first registered device of a plurality of registered devices having corresponding respective device profiles stored in the device registry;
generating, using the hardware processor, a ledger entry corresponding to the data in the data exchange ledger;
transmitting, using the hardware processor, a data availability notification describing the data to one or more other of the plurality of registered devices based on their respective device profiles;
receiving, using the hardware processor, a data acquisition request for the data from at least a second registered device included among the one or more other of the plurality of registered devices;
mediating, using the hardware processor, a transaction for an exchange of the data between the at least first registered device and the at least second registered device; and
updating, using the hardware processor, the ledger entry and the respective device profiles of the at least first registered device and the at least second registered device based on the transaction.

9. The method of claim 8, wherein the data exchange mediating software code further includes an analytics module, and wherein the method further comprises analyzing the data, using the hardware processor, before transmitting the data availability notification.

10. The method of claim 8, wherein the exchange of the data comprises a gift of the data from the at least first registered device to the at least second registered device.

11. The method of claim 8, wherein the exchange of the data comprises a sale of the data from the at least first registered device to the at least second registered device.

12. The method of claim 8, wherein the at least first registered device includes at least one component in common with the at least second registered device.

13. The method of claim 8, wherein the respective device profiles of the at least first registered device and the at least second registered device contain substantially identical device descriptive data.

14. The method of claim 8, further comprising modifying the data, using the hardware processor, before mediating the transaction.

15. A computer-readable non-transitory medium having stored thereon instructions, which when executed by a hardware processor, instantiate a method comprising:
receiving a data from at least a first registered device of a plurality of registered devices having corresponding respective device profiles stored in a device registry;
generating a ledger entry corresponding to the data in a data exchange ledger;
transmitting a data availability notification describing the data to one or more other of the plurality of registered devices based on their respective device profiles;
receiving a data acquisition request for the data from at least a second registered device included among the one or more other of the plurality of registered devices;
mediating a transaction for an exchange of the data between the at least first registered device and the at least second registered device; and
updating the ledger entry and the respective device profiles of the at least first registered device and the at least second registered device based on the transaction.

16. The computer-readable non-transitory medium of claim 15, wherein the method further comprises analyzing the data before transmitting the data availability notification.

17. The computer-readable non-transitory medium of claim 15, wherein the exchange of the data comprises a sale of the data from the at least first registered device to the at least second registered device.

18. The computer-readable non-transitory medium of claim 15, wherein the at least first registered device includes at least one component in common with the at least second registered device.

19. The computer-readable non-transitory medium of claim 15, wherein the respective device profiles of the at least first registered device and the at least second registered device contain substantially identical device descriptive data.

20. The computer-readable non-transitory medium of claim 15, wherein the method further comprises modifying the data before mediating the transaction.
